(19) United States
(12) Patent Application Publication
(10) Pub. No.: US 2014/0149139 A1
(43) Pub. Date: May 29, 2014

(54) METHOD AND SYSTEM FOR PROVIDING ACCESS TO HEALTH CARE INFORMATION

(71) Applicants: John Robert Bowen, JR., Metter, GA (US); Anthony C. Hethcox, Claxton, GA (US)

(72) Inventors: John Robert Bowen, JR., Metter, GA (US); Anthony C. Hethcox, Claxton, GA (US)

(21) Appl. No.: 13/687,201

(22) Filed: Nov. 28, 2012

(51) Int. Cl. G06Q 50/24

(52) U.S. Cl. CPC G06Q 50/24
USPC 705/3

(57) ABSTRACT

A system and method for providing a centralized source of health care information for an individual. Security measures for access to health care information of an individual may be provided. An interactive patient interface may be employed by the individual to gain access to the health care information, and an interactive provider interface may be employed by one or more health care providers of the individual to gain access to the health care information. Access and changes to the health care information from any of the health care providers and individual may be allowed as a function of a security level granted thereto.

### BACKGROUND

The effective, safe and secure administration of pharmaceuticals or medications to patients has become challenging because of the increasing population of patients and the number of drugs available for the treatment of disease. For healthcare providers to provide effective and safe treatment of a patient, the patient's medical record must contain accurate and up-to-date medication lists, laboratory and radiological results, recent or previous hospital records, and the content of other healthcare providers' notes.

Currently, healthcare providers rely upon incomplete data and/or spend an inordinate amount of time and effort collecting data for their own medical chart from other sources and such data may still be incomplete and inaccurate. For example, a physician may possess a list of medications the physician prescribed for a patient in an office chart, but the patient may be taking medications from other physicians and/or may not be taking medications as prescribed. Often the physician must call the patient's pharmacy(ies) to obtain an accurate list of medications for the patient and also frequency of prescription fills indicating whether the patient has been compliant with prior prescriptions and instructions. Even after taking time to contact a pharmacy, the physician may still have an incomplete drug list if the patient has been to multiple pharmacies.

Additionally, treating practitioners at a hospital may have access to patient data from previous admissions to the current facility (if any) but may not have access to other important medical information such as prescriptions, labs, x-rays, or other treating physicians' notes prior to the current admission. While much of the information necessary to provide safe patient care exists, the information is not easily accessible by the practitioners treating the patient nor is the information accessible from a single source and updatable from plural nodes. Rather, practitioners must contact other healthcare providers and facilities to request relevant patient information. Such a procedure, however, is inefficient and may provide incomplete information.

Furthermore, medical and other healthcare information can be sensitive and confidential. Laws such as the Health Insurance Portability and Accountability Act (HIPAA) limit or place specific conditions on the dissemination of medical records and also provide a patient with the right to access to his or her own medical records. Such privacy concerns may create problems for healthcare providers and physicians in the dissemination and sharing of medical information regarding patients. Additionally, even though a healthcare provider may be legally authorized to provide confidential and sensitive information as a result of a privacy policy, such disclosure may still be against the patient's wishes. Thus, there is a need in the art to provide secure access to medical records, which discloses all access to the patient. There is also a need in the art to provide an improved hospital admission medication reconciliation process and to provide patients with a more active role in their own treatment and care. Thus, by providing patients, healthcare providers, physicians, etc. with access to the patients' medical record, the accuracy and completeness of the medical record may be improved, and the potential for miscommunication between healthcare providers and patients may be reduced. There is thus a need in the art for a method and system to provide patients and healthcare providers with an accurate, complete, secure, and centralized medical record.

### SUMMARY

Embodiments of the present subject matter provide methods and systems for a secure, centralized, accurate and complete patient medical record adaptable to be accessed and modified by multiple nodes or parties in a secure manner.

One embodiment of the present subject matter provides a computer system having a computer readable storage medium being encoded with computer program code and a processor coupled with the computer readable storage medium, the processor being configured to execute the computer program code for providing access to health care information of one or more individuals. The computer program code may be arranged to cause the processor to provide security measures for access to the health care information and provide an interactive patient interface for the one or more individuals to the health care information. The computer program code may also be arranged to cause the processor to provide an interactive provider interface for one or more health care providers relating to the health care information of a respective individual, and to allow access to the health care information from any of the health care providers and respective individual as a function of a security level granted thereto.

In another embodiment of the present subject matter a method of providing a centralized source of health care information for an individual is presented. The method includes providing security measures for access to health care information of an individual and providing an interactive patient interface from a processor for the individual to the health care information. The method may also include providing an interactive provider interface for one or more health care providers of the individual and allowing access to the health care information from any of the health care providers and individual as a function of a security level granted thereto.

In a further embodiment of the present subject matter a method of providing an updated medical record for an individual is presented. The method includes providing security measures for access to health care information of an individual and providing an interactive patient interface from a processor for the individual to the health care information, the interactive patient interface including an active medications list, an all prescription list, and an inactive medications list. The method also includes providing an interactive provider interface for one or more health care providers of the individual, the interactive provider interface including an active medications list and an all prescription list. The method includes allowing access to the health care information from any of the health care providers and individual as a function of a security level granted thereto where the allowance of access includes viewing one or more of the frequency of prescription, duration of prescription, prescription notes, and pharmaceutical or trademark name of prescription related to a medication on a respective list.

### BRIEF DESCRIPTION OF THE DRAWINGS

FIG. 1 is a schematic drawing illustrating an exemplary network system.

FIG. 2 is an illustration of the movement of health information from a source computer to a user of an embodiment of the present subject matter.

FIG. 3 illustrates a non-limiting example of a patient interface employed by a user of an exemplary system to access information thereon.

FIG. 4 is a non-limiting example of an account interface employed by a user of an exemplary system to access account information available on a patient interface.

FIG. 5 is a non-limiting example of a refill reminder interface employed by a user of an exemplary system to access account information available on a patient interface.

FIG. 6 is a non-limiting example of a lab results or panel employed by a user of an exemplary system to access laboratory information available on a patient interface.

FIG. 7 is an illustration of a Basic Metabolic Profile lab panel in FIG. 6.

FIG. 8 is a non-limiting example of an X-rays and Procedure panel employed by a user of an exemplary system to access x-ray or procedural information available on a patient interface.

FIG. 9 is an illustration of an exemplary radiology results panel or page in FIG. 8.

FIG. 10 is a non-limiting example of a doctor's notes panel employed by a user of an exemplary system to access physician information available on a patient interface.

FIG. 11 is a non-limiting example of a hospital records panel or page employed by a user of an exemplary system to access hospital record information available on a patient interface.

FIG. 12 is an illustration of a selected hospital record page from the hospital records panel in FIG. 11.

FIG. 13 is an illustration of another selected hospital record page from the hospital records panel in FIG. 11.

FIG. 14 illustrates a non-limiting example of a physician interface employed by a user of an exemplary system to access information thereon.

FIG. 15 is a block diagram of one embodiment of the present subject matter.

FIG. 16 is a block diagram of another embodiment of the present subject matter.

### DETAILED DESCRIPTION

With reference to the figures, where like elements have been given like numerical designations to facilitate an understanding of the present subject matter, the various embodiments of a method and system for providing access to health care information are described.

The following description of the present subject matter is provided as an enabling teaching of the present subject matter and its best, currently-known embodiment. Those skilled in the art will recognize that many changes can be made to the embodiments described herein while still obtaining the beneficial results of the present subject matter. It will also be apparent that some of the desired benefits of the present subject matter can be obtained by selecting some of the features of the present subject matter without utilizing other features. Accordingly, those who work in the art will recognize that many modifications and adaptations of the present subject matter are possible and may even be desirable in certain circumstances and are part of the present subject matter. Thus, the following description is provided as illustrative of the principles of the present subject matter and not in limitation thereof. While the following exemplary discussion of embodiments of the present subject matter may be directed towards or references specific panels, pages and information thereon, it is to be understood that the discussion is not intended to limit the scope of the present subject matter in any way and that the principles presented are equally applicable to other information and methods of access thereto.

Those skilled in the art will appreciate that many modifications to the exemplary embodiments described herein are possible without departing from the spirit and scope of the present subject matter. Thus, the description is not intended and should not be construed to be limited to the examples given but should be granted the full breadth of protection afforded by the appended claims and equivalents thereto. In addition, it is possible to use some of the features of the present subject matter without the corresponding use of the other features. Accordingly, the foregoing description of exemplary or illustrative embodiments is provided for the purpose of illustrating the principles of the present subject matter and not in limitation thereof and may include modification thereto and permutations thereof. The terms “panel,” “page,” and “interface” are utilized interchangeably through the present disclosure and such use is not intended to limit the scope of the claims appended herewith. It should also be noted that the terms “information” and “data” are also utilized interchangeably through the present disclosure and such use is not intended to limit the scope of the claims appended herewith. Additionally, the terms “drugs” and “medications” may also be utilized interchangeably through the present disclosure and such use is not intended to limit the scope of the claims appended herewith.

One embodiment of the present subject matter provides a system and method for computerized collection of patient information from various sources using one or more interfaces between a network, server or other system and prescription switching company computers, pharmacy benefit managers' computers, e-script companies' computers, insurance companies' computers, pharmacies' computers, hospitals' computers, physicians' office computers (e.g., primary physician, radiologists, pathologists, and the like), laboratory and blood chemistry companies' computers (large providers contracting out services), radiology companies' computers (large providers contracting out services), and combinations thereof. Such collection and use of sensitive or confidential health information may be subject to compliance with Health Insurance Portability and Accountability Act (HIPAA) laws or other laws and policies.

One embodiment of the present subject matter provides a system and method for presenting collected health information of a patient in a user-friendly interface (website/web portal) while maintaining security of the patient's private health information. Such an interface may only allow access to the owner of the private health information (i.e., the patient) or an authorized user (health professional) who has signed a HIPAA business services agreement and consented to the terms of use and privacy policies of the company that owns/manages the web portal. In one embodiment, to provide further security of the private health information, a user's activity may be logged and/or visible to the patient (e.g., notification of frequency and date of the access, notification of the identity of such access, and notification of the type of information accessed). Additionally, different security levels may be employed as a function of the type of information to be accessed. Having such an access log visible to a patient may assist the patient in policing access to his or her records and may be later used against providers who access or use private health information improperly.

One embodiment of the present subject matter provides a method and system for providing security of private health information by employing security measures comparable to those measures utilized for access to financial accounts and secure databases including, but not limited to, data encryption, time-limited passwords, biometrics, alphanumeric criteria for passwords, passmarks, security questions, know your customer criteria, personal identification numbers, and combinations thereof.

Another embodiment of the present subject matter provides a method and system to provide a patient with secondary and tertiary information to provide education regarding a healthcare provider, pharmaceuticals, labs, x-rays, medical procedures, drug interactions, and other healthcare topics. Such information may be provided to the patient at a lower security level and may be made available to the patient by hyperlink. Exemplary information provided to a patient using such links may be, but is not limited to, pill images, drug interaction screening, information about laboratory tests and results, information about radiology tests and results, information about surgeries and other procedures, healthcare costs, prescription costs, patient assistance programs, and the like.

An additional embodiment of the present subject matter provides a method and system to allow a patient, caregiver, physician, and/or other healthcare provider the ability to maintain the patient's active medication list. In one embodiment, two separate medication lists may be provided for a patient: one being a list of all medications filled for a patient which includes an all-inclusive active and inactive medication list for the patient, the second being an active medication list for the patient which can be printed and provided to a healthcare provider or other entity to indicate what drugs a patient is currently taking. An exemplary active medication list may include, in one embodiment, routine, daily medications, pro re nata (PRN) medications taken as needed but remain active because they may be taken as often as needed, temporary medications having a defined future stop date, among others. In another embodiment, a patient's active medication list may be divided into a plurality of sections to indicate differences between the types of medications. Of course, a patient's active medication list may change from time to time as physicians add new medications, change medications, and/or discontinue medications. A patient or user of an exemplary embodiment may manually change the active medication list at any time by removing a medication from the active list, adding a new medication to the active list, etc.

One embodiment of the present subject matter may query a patient, physician, etc., with one or more predetermined questions upon login to determine and/or supplement the status of medications on an active medication list. By way of a non-limiting example, if a new medication is filled at a patient's pharmacy, an embodiment may inquire of a user (e.g., patient, pharmacy, etc.) at the next login if the medication is to be active, routine, PRN, temporary, etc. Depending upon the status of the medication, additional status information may be assigned such as a date by which the user will be notified when the medication is to be stopped. One embodiment may query a user about medications that have not been filled recently (greater than 50% past the day supply of the prescription) to determine if the medication is still active and or whether the medication should be removed from the active list. Of course, there may be instances when a medication may only appear not to be active, e.g., a patient is taking samples from his or her physician's office, due to the payment of a prescription with cash, the respective medication is not listed in the switch database, a patient is not taking the medication as prescribed, and any other reason that would cause the prescription not to be included in a switching company database. It should be noted that a physician may change how a medication is taken, e.g., frequency, etc., thus a user (the patient, physician, etc.) of an exemplary system may reflect the same change on the active medication list. Further, when a patient is admitted to a hospital, medication lists may often change during the hospital stay as physicians, nurses, and pharmacists may make changes to the patient's active medication list during the stay and at discharge to reflect any changes made during this period. At the time of discharge from a hospital, for example, an active medication list may be stored in a database or folder, e.g., a “hospital records” section, so that the medication list may be referred to later even after the active medication list has changed.

Another embodiment of the present subject matter provides a method and system for a patient to request refills from his or her pharmacy and sign up for refill reminders to be sent via email or text message or other means. A further embodiment of the present subject matter provides a method and system to allow access to patient insurance coverage information by a provider, the information including, but not limited to, eligibility status, identification numbers, insurance billing address, benefits, deductibles, co-pays, out-of-pocket expenses, prescription formularies, real-time test claims with co-pay information, and combinations thereof.

One embodiment of the present subject matter provides a method and system for physicians, pharmacists, etc. to exchange patient data. For example, an exemplary system may provide one or more interfaces between a centralized location and physicians' office computer systems to exchange patient data. Data may be available for the physician to import directly into their electronic medical record and may be available for export data to a centralized location to be stored in the patient's record for access by the patient or other healthcare providers who subscribe to services offered by embodiments of the present subject matter.

Yet a further embodiment provides a method and system for subscribing hospitals or other providers to access and exchange data in the same process a physician's office may do so. As hospitals may possess additional options for printing and exporting patients' medication lists, additional interfaces between embodiments of the present subject matter and subscribing hospitals' computer systems may be provided to ensure that medication lists and other data may be exported/imported as appropriate. For example, a hospital computer system may export a discharge list of medications into an embodiment of the present subject matter whereby such a list may reflect any changes to the patient's medication regimen during his or her respective hospital stay. In addition to importing a list of medications, the hospital may print the list as a standardized form or on a hospital designed form if desired. Furthermore, the hospital may import/export additional information in addition to medication lists (e.g., practitioners' notes, lab results, x-rays, etc.).

In another embodiment a method and system is provided for drug manufacturers and other manufacturers of medical supplies and equipment to advertise to patients and healthcare providers. For example, such a manufacturer may place their advertisements in view of specific users who prescribe to or use the products manufactured by competitors. That is, a patient may take Simvastatin® for treatment of high cholesterol whereby the makers of Crestor® (a comparable product for treatment of high cholesterol) may pay to have an advertisement for Crestor placed on the web page when a physician accesses that patient's record and/or on the web page when the patient views his or her own record. Of course, an option of having advertisement-free access to records is available.

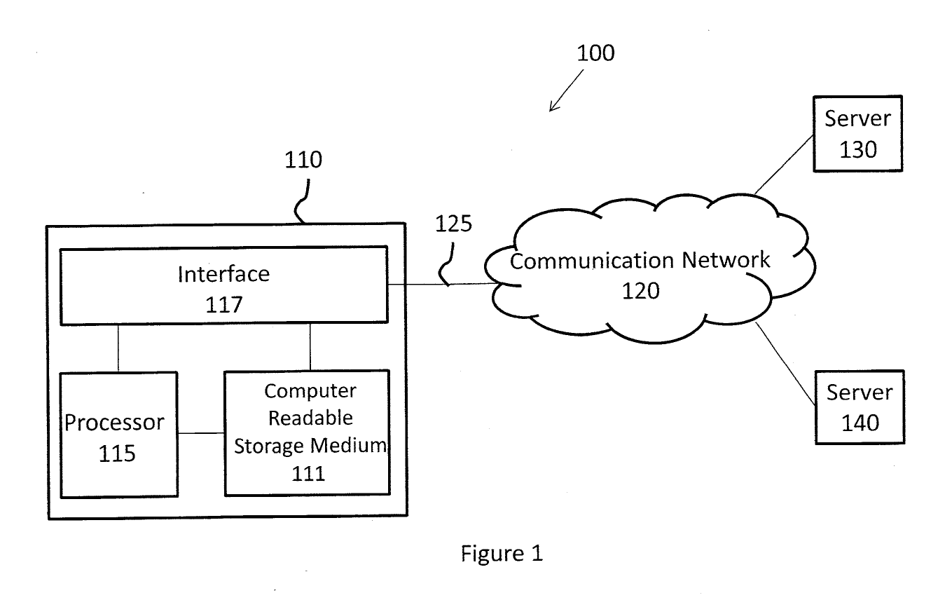

FIG. 1 is a schematic drawing illustrating an exemplary network system. With reference to FIG. 1, an exemplary network system 100 can include a computer system 110 coupled with servers 130 and 140 through a communication network 120. In some embodiments, the computer system 110 can include a computer readable storage medium 111 encoded with computer program code. The computer system 110 can include a processor 115 electrically coupled with the computer readable storage medium 111. The processor 115 can be configured to execute the computer program code for providing a secure, centralized, accurate and complete patient medical record. The processor 115 can be a central processing unit (CPU), a multi-processor, a distributed processing system, and/or any suitable processing unit.

In some embodiments, the computer readable storage medium 111 can be an electronic, magnetic, optical, electromagnetic, infrared, a semiconductor system (or apparatus or device), and/or a propagation medium. For example, the computer readable storage medium 111 can include a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 111 can include a compact disk-read only memory (CD-ROM), a compact disk-read/write (CD-R/W), and/or a digital video disc (DVD). In some embodiments, the computer program code stored in the computer readable storage medium 111 can include any other software or data that are used for providing a secure, centralized, accurate and complete patient medical record. In some embodiments, the software can be stored in the servers 130 and 140 and accessed through the communication network 120. For example, the computer system 110 can be electrically coupled with the communications network 120 through a wireless and/or wired link 125. The communication network 120 can be, for example, a complete network, a subnet of a local area network, a company-wide intranet, and/or the Internet. The computer system 110 can be identified on the communication network 120 by an address or a combination of addresses, such as a media address control (MAC) address associated with a network interface 117 and an internet protocol (IP) address. The network interface 117 can be, for example, a modem, a wireless transceiver, and/or one or more network interface cards (NICs).

In one embodiment, the computer system 110 includes a computer readable storage medium 111 being encoded with computer program code, and a processor 115 electrically coupled with the computer readable storage medium 111. The processor 115 may be configured to execute the computer program code for providing security measures for access to the health care information and for providing an interactive patient interface for the one or more individuals to the health care information. Exemplary health care information may be, but is not limited to, active medications, inactive medications, medication lists, drug interactions, physician's instructions, physician's notes, disease interactions, dosage, dose warnings, x-ray images, x-ray information, prescription information, hospital records, lab results, procedure information, procedure results, insurance information, pharmaceutical information, and combinations thereof. Such information may be stored locally or on a server or database remote from the processor. In another embodiment, the interactive patient interface includes one or more of an active medications list, an all prescription list, and an inactive medications list. Each of the lists may include one or more of frequency of prescription, quantity, duration of prescription, prescription notes, prescribing physician, Rx number, date of prescription, pharmaceutical or trademark name of prescription, and number of refills remaining related to a medication on that list. In another embodiment, the interactive patient interface includes hyperlinked pages to medical records, medication records, lab results, x-rays and procedure records, physician's notes, hospital records, and combinations thereof. Additionally, the interactive patient interface may include one or more sections for medical or non-medical advertisements.

The processor 115 may also be configured to execute the computer program code for providing an interactive provider interface for one or more health care providers relating to the health care information of a respective individual, and for allowing access to the health care information from any of the health care providers and respective individual as a function of a security level granted thereto. The interactive patient and provider interfaces may be graphical user interfaces. An exemplary health care provider may be a prescription switching company, pharmacy benefit manager, an e-script company, an insurance company, a pharmacy, a hospital, a physician, a physician's office, a radiologist, a pathologist, a laboratory and blood chemistry company, a radiology company, a pharmaceutical company, and combinations thereof. Of course, each of these entities may have limited access, if any, to the private health information of a patient. For example, certain providers such as, but not limited to, doctors, patients and hospitals may be provided with two-way access to embodiments of the present subject matter and may thus be allowed to receive certain private health information of a patient and modify or change certain private health information of a patient. It follows that other providers such as, but not limited to, switching companies, radiology companies, pharmaceutical companies, PBMs, e-script companies, insurance companies, and blood chemistry companies may be provided with only one-way access to embodiments of the present subject matter, that is, such companies may only be allowed to provide data into exemplary systems but may not be allowed to access, modify and/or receive private health information of a patient. In one embodiment, the interactive provider interface includes one or both of an active medications list and an all prescription list. These lists may include one or more of frequency of prescription, quantity, duration of prescription, prescription notes, prescribing physician, Rx number, date of prescription, pharmaceutical or trademark name of prescription, and number of refills remaining related to a medication on that list. In another embodiment, the interactive provider interface includes hyperlinked pages to medical records, medication records, lab results, x-rays and procedure records, physician's notes, hospital records, and combinations thereof. Additionally, the interactive provider interface may include one or more sections for medical or non-medical advertisements. In one embodiment, the granted security level may be dependent upon whether the individual or provider is the originating source of the respective health care information. Exemplary security measures may be, but are not limited to, data encryption methods, time-limited passwords, biometrics, alphanumeric criteria for passwords, passmarks, security questions, know your customer criteria, personal identification numbers, and combinations thereof.

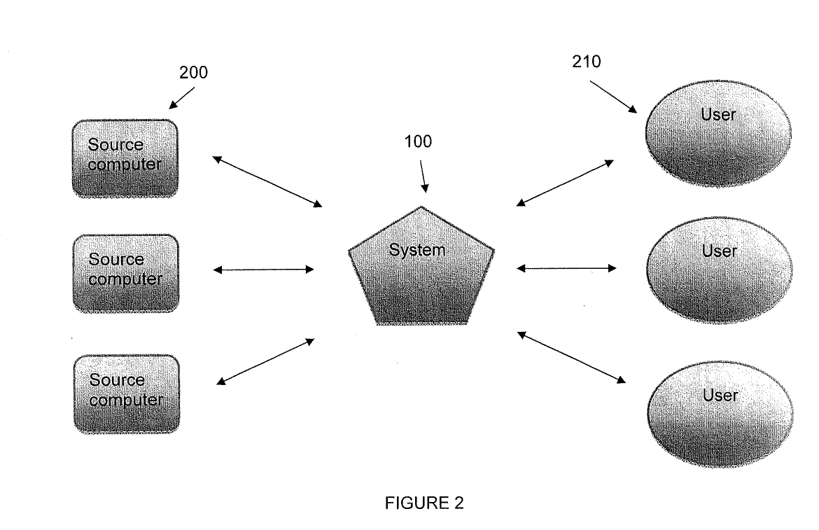

FIG. 2 is an illustration of the movement of health information from a source computer, processor or device to a user of an embodiment of the present subject matter. With reference to FIG. 2, a source computer 200 may be one or more of a prescription switching company computer, pharmacy benefit manager's computers, e-script company's computers, insurance company's computers, pharmacy's computers, hospital's computers, physician's office computers, laboratory and blood chemistry company's computers (e.g., large providers or companies that contract out services), radiology company's computers (large providers or companies that contract out services), and combinations thereof. Any one or several of the source computers 200 may be in communication with an exemplary network system 100 via wireless or wireline protocols. As noted above, these source computers 200 may have limited access, if any, to the private health information of a patient. Thus, certain health care providers such as, but not limited to, doctors, patients and hospitals may be provided with two-way access to embodiments of the present subject matter and may thus be allowed to receive and access certain private health information of a patient and/or modify or change certain private health information of a patient. Other providers such as, but not limited to, switching companies, radiology companies, pharmaceutical companies, PBMs, e-script companies, insurance companies, and blood chemistry companies may be provided with only one-way access to embodiments of the present subject matter, that is, such companies may only be allowed to provide data into exemplary systems but may not be allowed to access, modify and/or receive private health information of a patient. Thus, the two-way arrow depicted in FIG. 2 should not limit the scope of the claims appended herewith. The network system 100 may store health information received from the source computer(s) 200 and control access to and delineation of information within the system 100 to a user 210 of the system 100 to ensure security of the information or data. The user 210 may access the system 100 using, for example, a web portal. In one embodiment, a user 210 of the system 100 may be an entity or individual using a source computer 200. Exemplary security of the information such as private health information may be accomplished by employing security measures comparable to those utilized for access to financial accounts and secure databases including, but not limited to, data encryption, time-limited passwords, biometrics, alphanumeric criteria for passwords, passmarks, security questions and know your customer criteria, personal identification numbers, and combinations thereof. Thus, embodiments of the present subject matter may provide a secure cyber-chart or cyber medical record. Of course, additional security measures may be provided to the servers, networks, computers, etc. that store such private health information or data. In one embodiment, users 210 may be required to agree to terms of use and the like to guard against misuse of the system 100 or the private health information contained therein. Users such as, but not limited to, healthcare professionals or providers may be required to sign HIPAA business service agreements and agree to company privacy policies. Furthermore, user activity may be logged or stored in the system 100 and/or visible to the patient or other entity (e.g., notification of frequency and date of access of information, notification of the identity of the entity gaining or requesting such access, notification of the type of information accessed, and the like). Additionally, different security levels may be employed as a function of the type of information to be accessed. Having such an access log visible to and accessible by a patient may assist the patient in policing access to his or her records and may be later used against providers who access or use private health information improperly, e.g., a user violates HIPAA law or the terms of use for the website or portal.

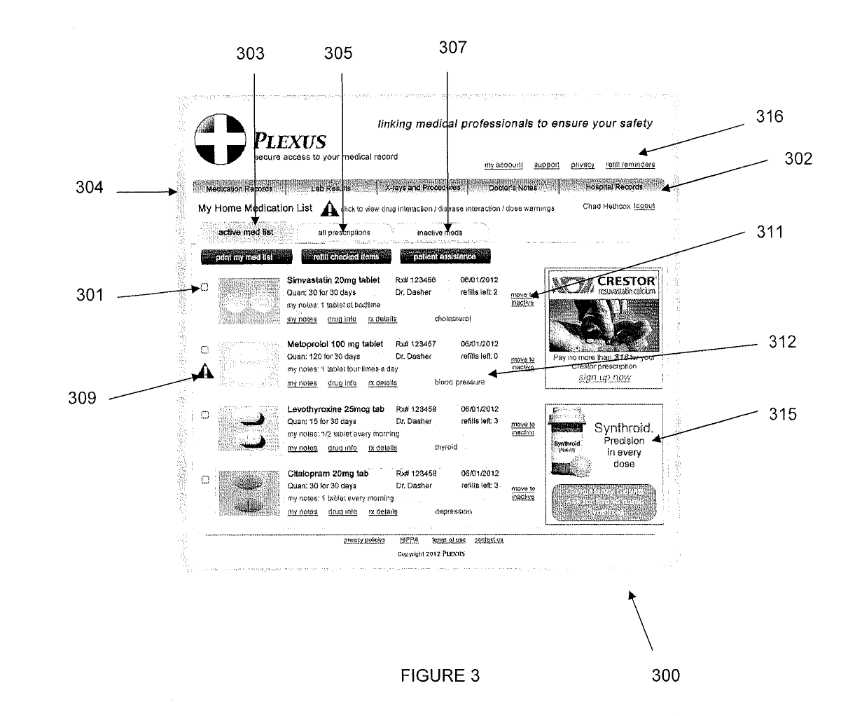

FIG. 3 illustrates a non-limiting example of a patient interface 300 employed by a user of an exemplary system 100 to access information thereon. With reference to FIG. 3, an exemplary patient interface 300 presents a graphical user interface of a conventional kind. This main window presents a menu bar 302 with the following top menus: Medication Records, Lab Results, X-rays and Procedures, Doctor's Notes, and Hospital Records. Of course, such top menus are exemplary only and should not limit the scope of the claims appended herewith. Sub-menu bars 304 may be provided on the interface 300 including, but not limited to: an active medication list, all prescription list, and inactive medication list. The all prescription list 305 may include a list of all medications filled for a patient which includes an all-inclusive active and inactive medication list for the patient. The active medication list 303 may indicate what medications a patient is currently taking (e.g., routine, daily medications, PRN medications taken as needed but remain active because they may be taken as often as needed, temporary medications having a defined future stop date, among others). In another embodiment, a patient's active medication list 303 may be divided into a plurality of sections to indicate differences between the types of medications. Of course, a patient's active medication list 303 may change from time to time as physicians add new medications, change medications, and/or discontinue medications. As depicted in FIG. 3, the active medication list 303 has been called up and under this menu, a patient or user may manually change the active medication list at any time by removing a medication from the active list, adding a new medication to the active list, etc. by simply clicking on a box 301 to the left of the respective medication to add to the active medication list 303 or by clicking on a hyperlink 311 to move the medication to the inactive list 307. The inactive medication list 307 may include a list of medications no longer taken by the respective patient. In any of the medications provided on the lists 303, 305, 307, additional information may be provided such as, but not limited to, frequency of prescription, quantity, duration of prescription, prescription notes, prescribing physician, Rx number, date of prescription, pharmaceutical or trademark name of prescription, number of refills remaining, etc.

Additional hyperlinks and information 312 may be provided in the lists 303, 305, 307 including patient notes, drug information, pharmacy information, physician information or instructions and additional information including general type of drug (e.g., cholesterol, blood pressure, thyroid medicine, etc.). In the event that some of the medications in any of the medication lists provide an adverse interaction with any other medication on any of the medication lists, then an alert 309 may be provided on the list 303, 305, 307 to provide additional information to a user of the system 100. Of course, alerts 309 may be provided for other reasons such as, but not limited to, physician's notes, physician's instructions, disease interaction, dose warnings, etc.

The patient interface 300 may also include function buttons 310 for different features of the system 100 including, but not limited to, print my medication list, refill checked items, patient assistance, etc. In one embodiment, these function buttons 310 may be changeable by the patient and/or another user of the system 100. The patient interface 300 may include sections 315 provided for drug manufacturers and other manufacturers of medical supplies and equipment to provide advertisements to patients and healthcare providers. Of course, non-medical related advertisers may use this space for the same purpose. For example, a drug manufacturer may place their advertisements in view of specific users who prescribe or use the products manufactured by competitors. Of course, the patient may select an option of having advertisement-free access to his or her records. Additional areas 316 may be provided on the patient interface 300 including hyperlinks for a patient to access his or her account, request support, access privacy terms, and access prescription reminder information, among others.

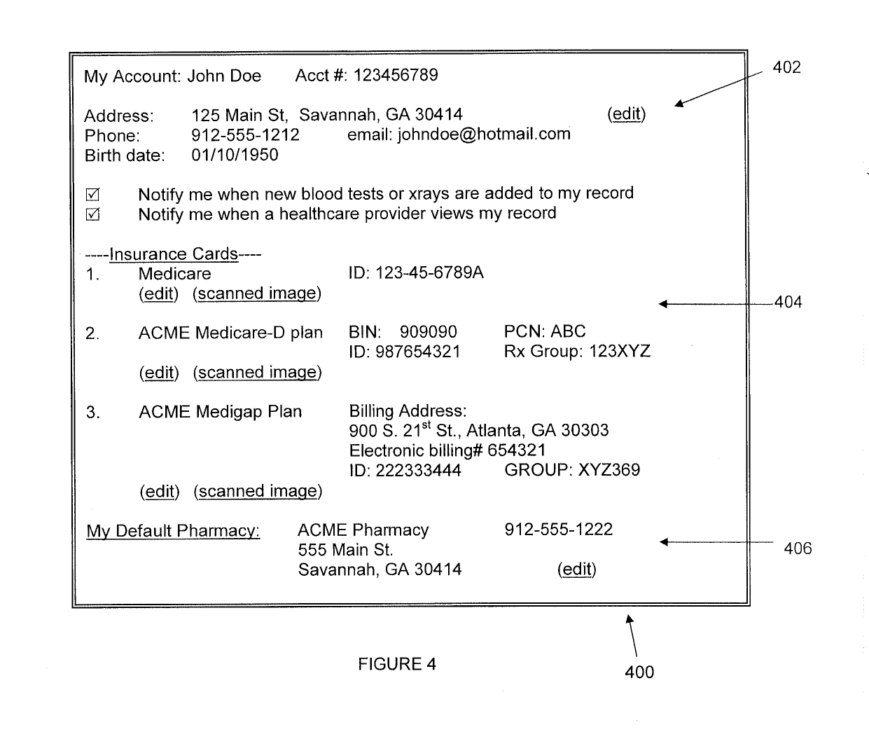

FIG. 4 is a non-limiting example of an account interface 400 employed by a user of an exemplary system to access account information available on the patient interface 300. With reference to FIG. 4, an exemplary account interface 400 may present a graphical user interface of a conventional kind. Such an interface 400 may provide a patient with access to view or change his or her respective demographic data 402 including, but not limited to, address, phone, email, birth date, and other information. The patient may also view, edit, and upload images (not shown) of or information contained on insurance cards 404, which can then be downloaded by healthcare providers requiring such information to bill the respective patient for services and/or products. Additionally, identification information for the patient's pharmacy(ies) may be provided. In another embodiment, prescription card information may be employed by a provider or physician to send a prescription test claim. Of course, information from the insurance card (identification numbers, billing addresses, etc.) can be entered in addition to, or in lieu of a scanned image of the actual card.

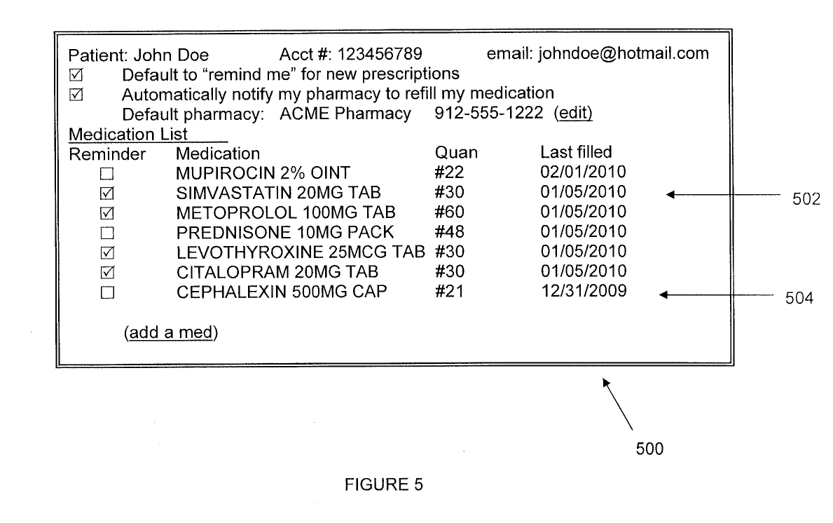

FIG. 5 is a non-limiting example of a refill reminder interface 500 employed by a user of an exemplary system to access account information available on the patient interface 300. With reference to FIG. 5, an exemplary refill reminder interface 500 may present a graphical user interface of a conventional kind. Such an interface 500 may be employed, in one embodiment, to select which medications 502 a patient (or other user of the system 100) is desirous of being reminded to refill. Of course, some medications 504 should not or cannot be refilled due to the type of medication, so the patient may not be able to be reminded to refill those medications. In one embodiment, information regarding drug interactions, restrictions, and limitations for medications on the lists may be stored in a database of an exemplary system 100. In one embodiment, an exemplary system 100 may transmit to the patient an email or text message when a prescription is due to be refilled using appropriate wireless and/or wireline interfaces. Alternatively, a patient's pharmacy and/or physician may receive a notification to refill the prescription if the patient so chooses or may receive a notification if a patient has failed to fill or refill the prescription.

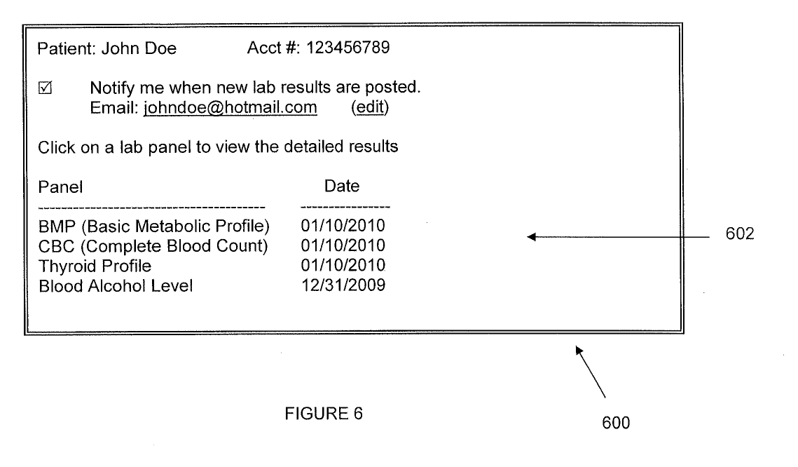

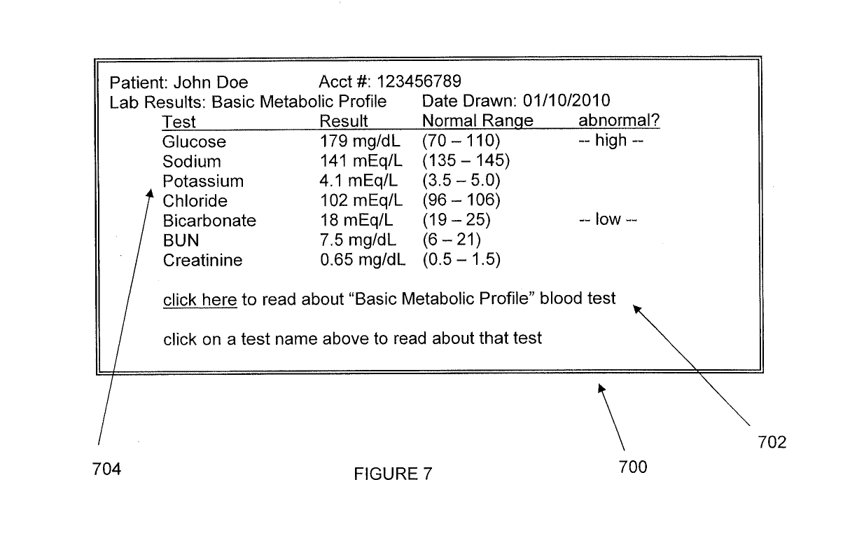

FIG. 6 is a non-limiting example of a lab results page, interface or panel 600 employed by a user of an exemplary system to access laboratory information available on the patient interface 300. With reference to FIG. 6, an exemplary lab result page or interface 600 may present a graphical user interface of a conventional kind and may be employed, in one embodiment, to provide information regarding the number, type, and date of lab panels 602 performed on the patient. In one embodiment, each lab panel 602 may be provided with a hyperlink allowing the patient to observe the results of the lab panel 602 (see FIG. 7). Of course, in one embodiment, the patient may be notified when new lab panels are posted to the system 100.

FIG. 7 is an illustration of the Basic Metabolic Profile (BMP) lab panel depicted in FIG. 6. With reference to FIG. 7, a patient may access a specific lab panel identified in the lab panel interface 600 by selecting, in this case, BMP lab test results 700. Additional hyperlinks may be provided to allow a patient to access information regarding the specific BMP test 702 (e.g., to determine what tests are in a BMP test, what are considered normal results, and why a physician would order a BMP test) or for specific sub-tests 704 within the overall BMP test 702. For example, a patient may select “Glucose,” “Sodium,” etc., to read the reasons to test glucose, sodium, etc. levels as well as what high or low levels may indicate.

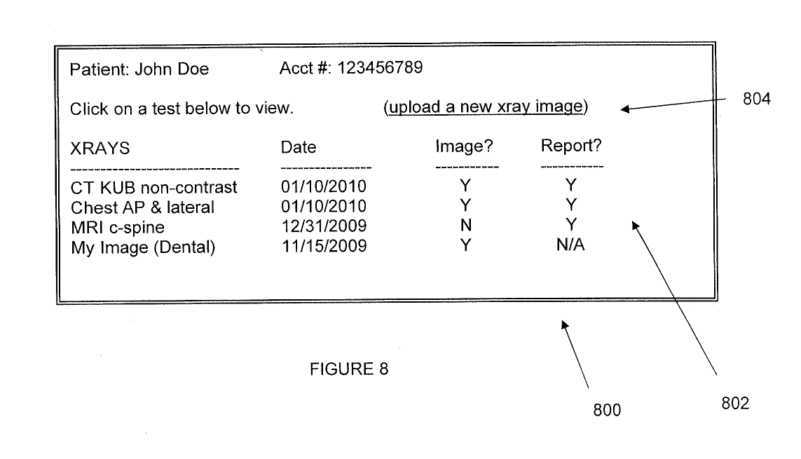

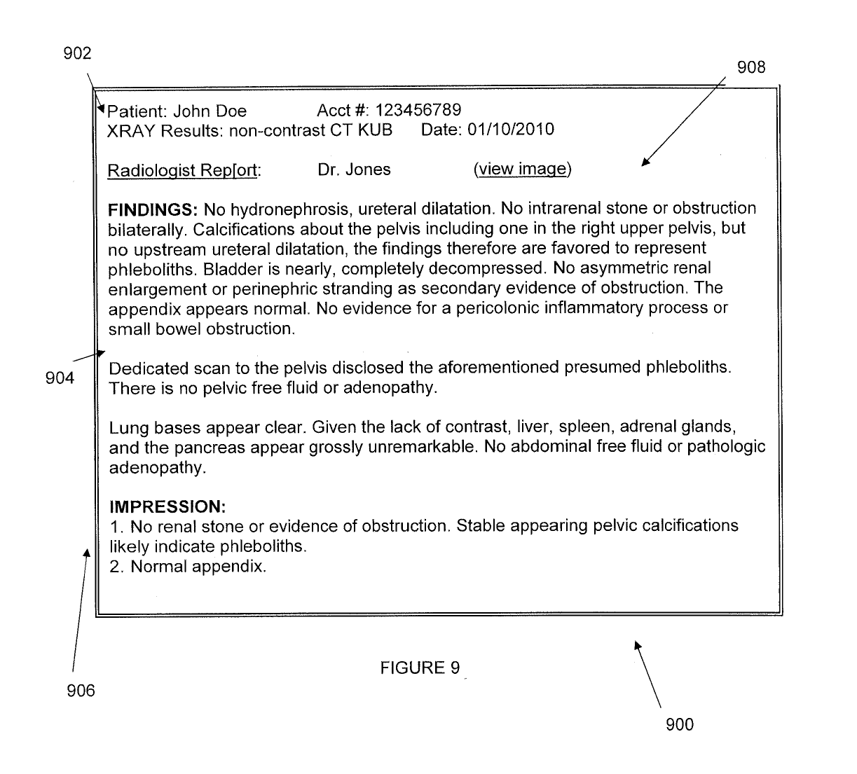

FIG. 8 is a non-limiting example of an x-rays and procedure panel 800 employed by a user of an exemplary system to access x-ray or procedural information available on the patient interface 300. With reference to FIG. 8, an exemplary x-ray and procedure panel or interface 800 may present a graphical user interface of a conventional kind and may be employed, in one embodiment, to provide information regarding the number, type, and date of an x-ray or procedure 802 performed on the patient. In one embodiment, each x-ray or procedure 802 may be provided with a hyperlink allowing the patient to observe and/or download the results of or images associated with the x-ray or procedure 802 (see FIG. 9). In one embodiment, the patient, physician or other user may access a hyperlink 804 to upload a new x-ray image or procedure if additional images or information are available for upload to the system 100.

FIG. 9 is an illustration of an exemplary radiology results panel or page depicted in FIG. 8. With reference to FIG. 9, a patient may access a specific x-ray or procedure results page 900 identified in the x-ray and procedure interface 800 by selecting, in this case, non-contrast computed tomography (CT) kidneys, ureters, and bladder (KUB) x-ray results 902. In this page, a physician or radiologist may provide specific findings 904 and impressions 906 regarding the specific x-ray or procedure, in this case, a non-contrast CT KUB. Additional hyperlinks may be provided to allow a patient to access information regarding the x-ray or procedure and/or download or access the x-ray image or information 908 from the procedures (CT results).

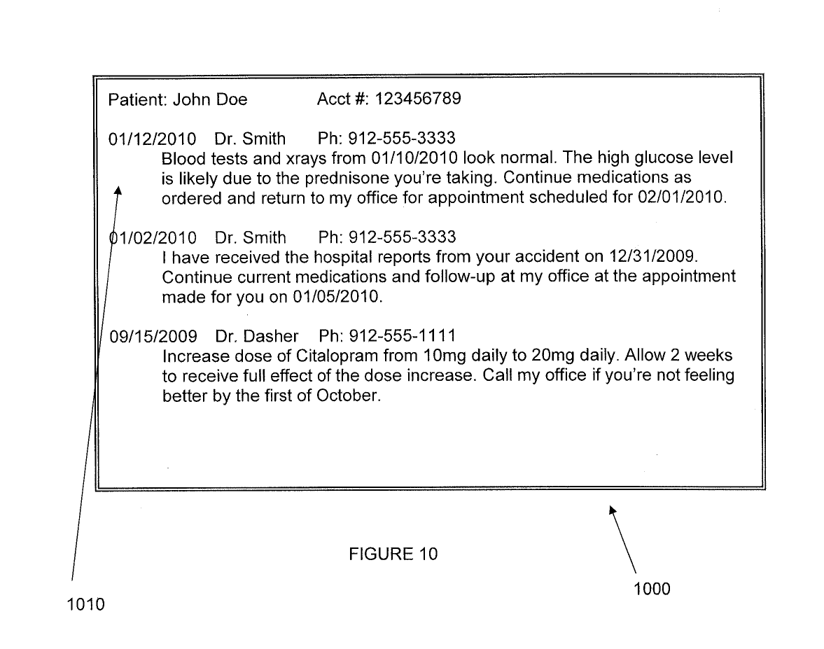

FIG. 10 is a non-limiting example of a doctor's notes panel, page or interface employed by a user of an exemplary system to access physician information or “notes” available on the patient interface 300. With reference to FIG. 10, an exemplary doctor's notes panel or interface 1000 may present a graphical user interface of a conventional kind and may be employed, in one embodiment, to provide information 1010 regarding the number, type, and date of a doctor's visit, contact information, and specific information provided or requested by the physician during a medical visit. While not shown, additional notifications by the physician may be provided to a patient.

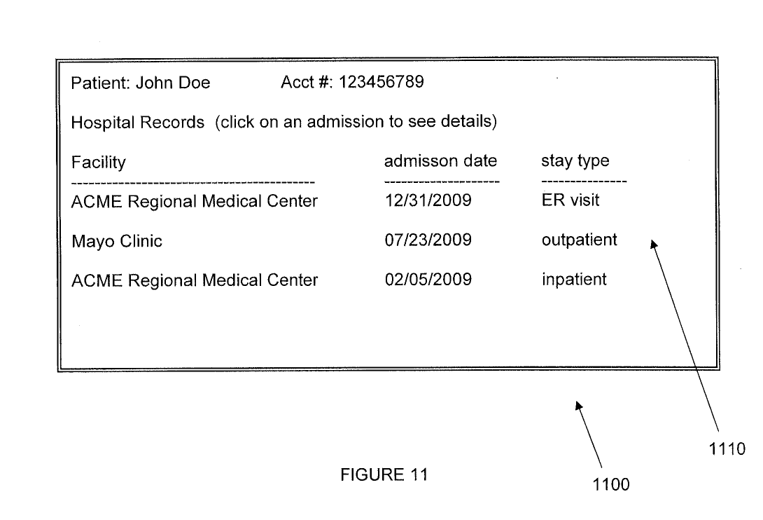

FIG. 11 is a non-limiting example of a hospital records panel or page employed by a user of an exemplary system to access hospital record information available on the patient interface 300. With reference to FIG. 11, an exemplary hospital records panel or interface 1100 may present a graphical user interface of a conventional kind and may be employed, in one embodiment, to provide information 1110 regarding the facility, admission date, stay type of a patient's hospital stay(s). In one embodiment, a user may select a hospital stay to view by clicking on the stay entry. A hospital stay record may be generated any time a patient is admitted to a hospital for a procedure, observation, inpatient stay, outpatient treatment, etc. Computer and networking interfaces between the respective hospital system and an exemplary system 100 may provide for the import and export of data and information related to the patient's hospital stay(s). Additionally, the hospital may import medication lists and medical information from prior to admission, and the hospital may export medical information related to the current admission. It follows that hospital records may only be edited by the hospital staff, and the patient and other users not employed by the hospital may only access, view and/or print such hospital records.

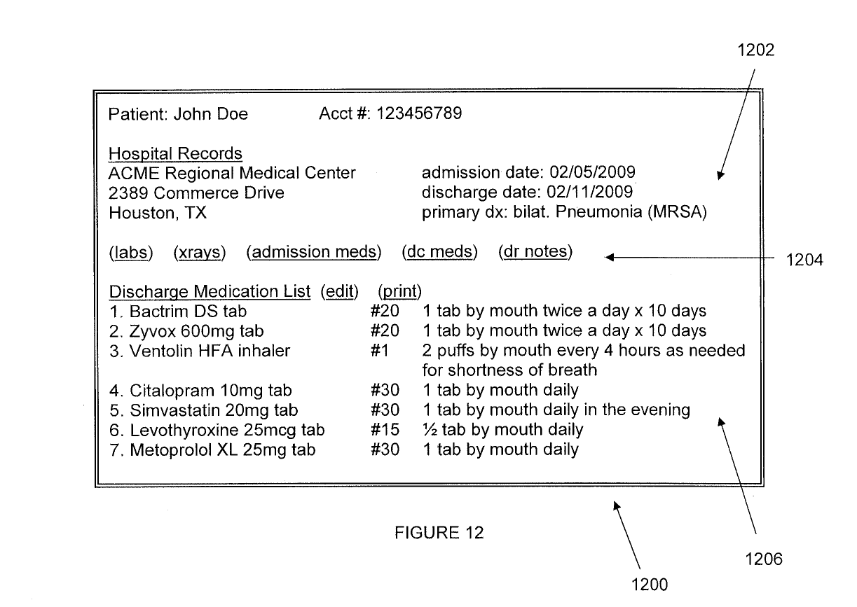

FIG. 12 is an illustration of a selected hospital record page from the hospital records panel in FIG. 11. With reference to FIG. 12, a patient may access information 1200 specific to a hospital stay including general hospital information available in a first section 1202 having the admission date, discharge date, reasons for admission, and the like. Additional menu bars 1204 may be available including hyperlinks providing lab results, x-rays, admission medication lists, discharge (dc) medication lists and doctor's notes. In the illustrated embodiment, a discharge medication list 1206 is provided including medications prescribed by physicians for the patient while admitted during the respective hospital stay. Information included in the list may be, but is not limited to, the generic or specific name of the prescription, frequency and fill data, and the like. In one embodiment, the discharge medication list may be exported to the patient's active medication list depicted in FIG. 3 to supplement data therein. In another embodiment, this discharge medication list may supersede or supplant any medications provided on the active medication list. This discharge medication list may remain in the hospital records section so that when the patient's active medication list is changed there is a permanent record of the patient's medication list at the time of discharge. Of course, in the hospital records section, the labs, x-rays, and practitioner's notes screens or pages may appear the same as described herein.

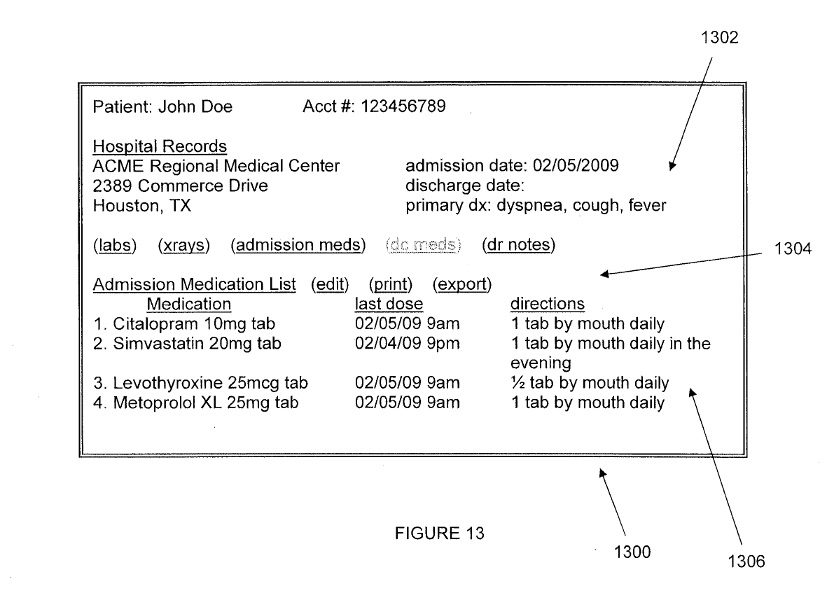

FIG. 13 is an illustration of a selected hospital record page from the hospital records panel in FIG. 11. With reference to FIG. 13, a patient may access information 1300 specific to a hospital stay including general hospital information available in a first section 1302 having the admission date, discharge date, reasons for admission, and the like. Additional menu bars 1304 may be available including hyperlinks providing lab results, x-rays, admission medication lists, discharge medication lists and doctor's notes. In the illustrated embodiment, an admission medication list 1306 is provided which may be imported from the patient's active medication list depicted in FIG. 3; however, the admission medication list may be edited by hospital staff at the time of admission. Information included in the list may be, but is not limited to, the generic or specific name of the prescription, frequency data, last dose of the medication, and the like. The admission medication list may also be exported to the hospital system or printed by staff as needed. Such an ability to create a list of medications upon admission from an existing list may assist in the prevention of transcription errors and may aid in cases when the patient or caregiver is unable to provide medical information.

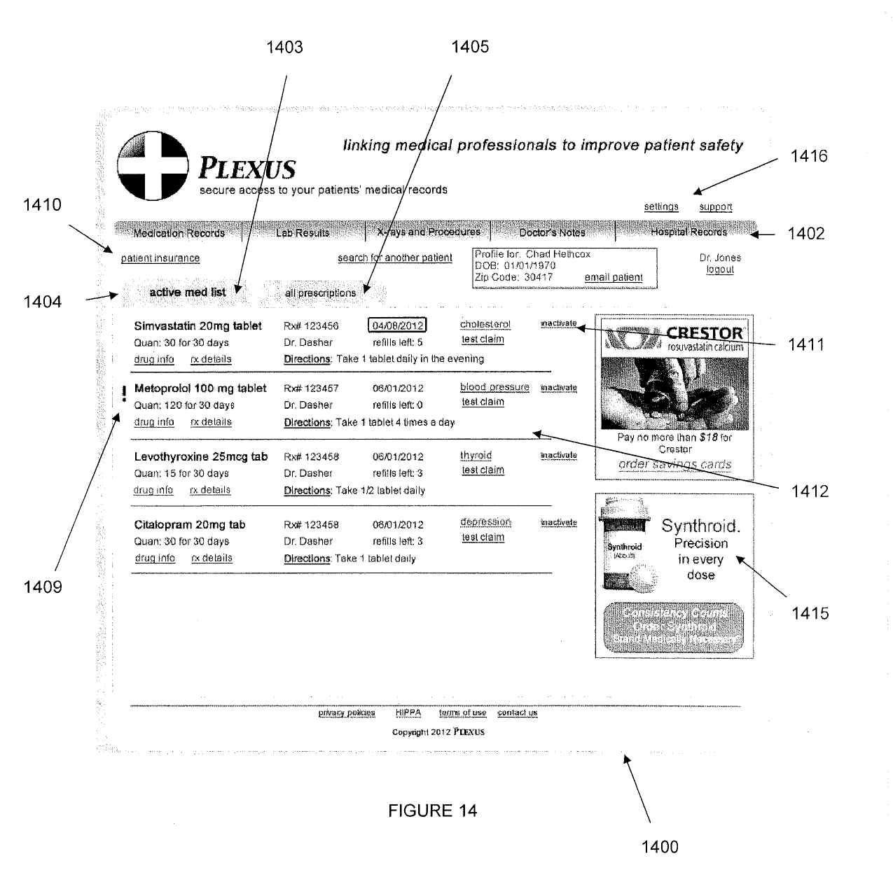

FIG. 14 illustrates a non-limiting example of a physician interface employed by a user of an exemplary system to access information thereon. With reference to FIG. 14, an exemplary physician interface 1400 presents a graphical user interface of a conventional kind. This main window presents a menu bar 1402 with the following, non-limiting top menus: Medication Records, Lab Results, X-rays and Procedures, Doctor's Notes, and Hospital Records. Of course, such top menus are exemplary only and should not limit the scope of the claims appended herewith. Sub-menu bars 1404 may be provided on the interface 1400 including, but not limited to: an active medication list and all prescription list. The all prescription list 1405 may include a list of all medications filled for a patient which includes an all-inclusive active and inactive medication list for the patient. The active medication list 1403 may indicate what medications a patient is currently taking (e.g., routine, daily medications, PRN medications taken as needed but remain active because they may be taken as often as needed, temporary medications having a defined future stop date, among others). In another embodiment, a patient's active medication list 1403 may be divided into a plurality of sections to indicate differences between the types of medications. Of course, a patient's active medication list 1403 may change from time to time as physicians add new medications, change medications, and/or discontinue medications. As depicted in FIG. 14, the active medication list 1403 has been called up and under this menu or list, a physician or user may manually change the active medication list at any time by removing a medication from the active list by clicking on a hyperlink 1411 to move the medication to an inactive list or by adding a new medication to the active list. In any of the medications provided on the lists 1403, 1405 additional information may be provided such as, but not limited to, frequency of prescription, quantity, duration of prescription, prescription notes, prescribing physician, Rx number, date of prescription, pharmaceutical or trademark name of prescription, number of refills remaining, etc.

Additional hyperlinks and information 1412 may be provided in the lists 1403, 1405 including drug information, pharmacy information, physician information or instructions and additional information including general type of drug (e.g., cholesterol, blood pressure, thyroid medicine, etc.). In the event that some of the medications in any of the medication lists provide an adverse interaction with any other medication on any of the medication lists, then an alert 1409 may be provided on the list 1403, 1405 to provide additional information to a user of the system 100. Of course, alerts 1409 may be provided for other reasons such as, but not limited to, physician's notes, physician's instructions, disease interaction, dose warnings, etc.

The physician interface 1400 may also include function buttons 1410 for different features of the system 100 including, but not limited to, accessing information about the respective patient's insurance, searching for additional patients, etc. In one embodiment, these function buttons 1410 may be changeable by the physician and/or another user of the system 100. The physician interface 1400 may include sections 1415 provided for drug manufacturers and other manufacturers of medical supplies and equipment to provide advertisements to healthcare providers. Of course, non-medical related advertisers may use this space for the same purpose. For example, a drug manufacturer may place their advertisements in view of specific users who prescribe or use the products manufactured by competitors. Of course, the physician may select an option of having advertisement-free access to records. Additional areas 1416 may be provided on the physician interface 1400 including hyperlinks for a physician to request support, access privacy terms, change settings, etc.

Thus, when a physician logs into a patient's record, the physician may be, in one embodiment, provided with the patient's active medication list whereby the physician or user may have the option to access the following areas from this page 1400: a complete medication list (including inactive medications), details of each prescription (including filling history and patient's notes), lab results, radiology results, practitioners' notes, hospital records, settings (including the user's preferences and personal information), hyperlinks to website support (including support by phone, email, chat, or knowledge base), patient insurance records, test claims (including a list of alternative drugs with patient copay amount and formulary tier), hyperlinks to drug information for each drug (prescribing information such as dosing, contraindications and precautions, drug-interactions, adverse reactions, pharmacokinetics, etc.), hyperlinks to move the drug to the inactive list, hyperlinks to change the prescription directions, hyperlinks to change the indication (for what the prescription is used), notations (a large, red exclamation mark) by any medication with warnings indicating possible drug interaction, improper dose, or drug allergy (the exclamation mark may in one embodiment serve as a link to the explanation of the warning), and other prescription information including the prescribing physician, last prescription number, refills left, last date filled, day supply, and quantity filled.

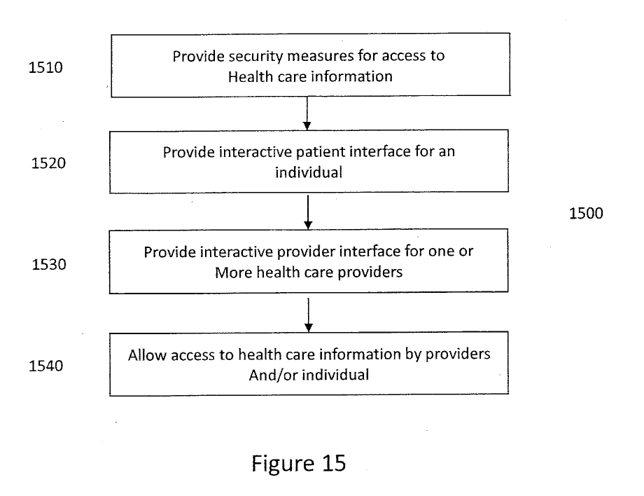

FIG. 15 is a block diagram of one embodiment of the present subject matter. With reference to FIG. 15, a method 1500 of providing a centralized source of health care information for an individual is presented. Exemplary health care information may be, but is not limited to, active medications, inactive medications, medication lists, drug interactions, physician's instructions, physician's notes, disease interactions, dosage, dose warnings, x-ray images, x-ray information, prescription information, hospital records, lab results, procedure information, procedure results, insurance information, pharmaceutical information, and combinations thereof. The method may include at step 1510 providing security measures for access to health care information of an individual and at step 1520 providing an interactive patient interface from a processor for the individual to the health care information. In one embodiment, step 1520 includes providing a web page to the individual having one or more of an active medications list, an all prescription list, and an inactive medications list. In such an embodiment, the step of allowing access further comprises allowing the individual to switch medications between active and inactive medication lists; however, the patient may not be allowed to alter certain data such as, but not limited to, quantity dispensed, Rx number, date of prescription, number of refills, etc. In one embodiment, an alert may be generated notifying a user (the patient and/or the prescribing physician or entity) that the user's movement of a medication from one list to another does not comport with the instructions (e.g., duration, quantity, etc.) provided by the originating source (e.g., physician). In such an embodiment, the user be provided with an additional page such as a pop-up page, notifying him or her of such a discrepancy between the instructions and current action. In another embodiment, step 1520 includes providing hyperlinked pages to medical records, medication records, lab results, x-rays and procedure records, physician's notes, hospital records, and combinations thereof. In an exemplary embodiment, when a change or modification has been implemented in the private health information of a patient by an entity (e.g., a physician, hospital, etc. or even the patient himself), such modifications to the underlying data may be indicated to other parties by any number of means such as, but not limited to, strike-throughs, comments, notes or the like, to ensure that the original data is left intact and changes viewable by all parties. In one embodiment, the system may be provided with one or more history pages which provide such changes accessible by all parties so as to leave the medical records, medication records, etc. pages uncluttered. In another embodiment, such changes may be viewable on the original medical records, medication records, etc. pages for a predetermined time period and then automatically moved to the respective history page(s).

An interactive provider interface for one or more health care providers of the individual may be provided at step 1530. Exemplary health care providers may be, but are not limited to, a prescription switching company, pharmacy benefit manager, an e-script company, an insurance company, a pharmacy, a hospital, a physician, a physician's office, a radiologist, a pathologist, a laboratory and blood chemistry company, a radiology company, a pharmaceutical company, and combinations thereof. In one embodiment, step 1530 includes providing a web page to the provider having one or more of an active medications list and an all prescription list. In such an embodiment, the step of allowing access further comprises allowing the provider to change frequency of prescription, quantity, duration of prescription, prescription notes, prescribing physician, Rx number, date of prescription, pharmaceutical or trademark name of prescription, or number of refills remaining related to a medication on a respective list. In another embodiment, step 1530 includes providing hyperlinked pages to medical records, medication records, lab results, x-rays and procedure records, physician's notes, hospital records, and combinations thereof. In such an embodiment, the step of allowing access further comprises allowing the provider to change information in the medical records, medication records, lab results, x-rays and procedure records, physician's notes, or hospital records.

At step 1540, access to the health care information from any of the health care providers and individual may be allowed as a function of a security level granted thereto. In one embodiment, the granted security level is dependent upon whether the individual or provider is the originating source of the respective health care information. Exemplary security measures may be, but are not limited to, data encryption methods, time-limited passwords, biometrics, alphanumeric criteria for passwords, passmarks, security questions, know your customer criteria, personal identification numbers, and combinations thereof.

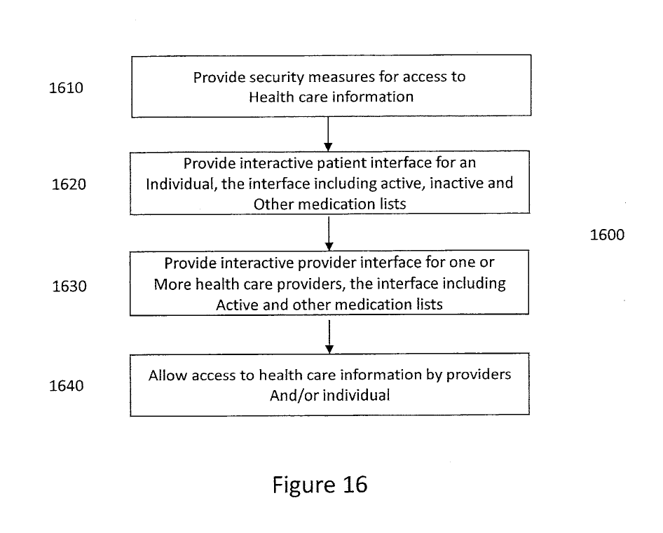

FIG. 16 is a block diagram of another embodiment of the present subject matter. With reference to FIG. 16, a method 1600 is provided for presenting an updated medical record for an individual. The method may include providing security measures for access to health care information of an individual at step 1610. At step 1620, an interactive patient interface from a processor may be provided for the individual to the health care information, the interactive patient interface including an active medications list, an all prescription list, and an inactive medications list. In one embodiment, step 1620 includes providing hyperlinked pages to medical records, medication records, lab results, x-rays and procedure records, physician's notes, hospital records, and combinations thereof. In such an embodiment, the step of allowing access may further comprise allowing the individual to change only certain information in the medical records, medication records, lab results, x-rays and procedure records, physician's notes, or hospital records.

At step 1630, an interactive provider interface may be provided for one or more health care providers of the individual, the interactive provider interface including an active medications list and an all prescription list. In one embodiment, step 1630 includes providing hyperlinked pages to medical records, medication records, lab results, x-rays and procedure records, physician's notes, hospital records, and combinations thereof. In such an embodiment, the step of allowing access may further comprise allowing the provider to change information in the medical records, medication records, lab results, x-rays and procedure records, physician's notes, or hospital records. At step 1640, access to the health care information from any of the health care providers and individual may then be allowed as a function of a security level granted thereto where the step of allowing access includes changing one or more of the frequency of prescription, duration of prescription, prescription notes, pharmaceutical or trademark name of prescription, and other information related to a medication on a respective list.

The present disclosure may also be implemented by a general purpose computer programmed in accordance with the principals discussed herein. It may be emphasized that the above-described embodiments, particularly any “preferred” or exemplary embodiments, are merely possible examples of implementations, merely set forth for a clear understanding of the principles of the present subject matter. Many variations and modifications may be made to the above-described embodiments of the present subject matter without departing substantially from the spirit and principles of the present subject matter. All such modifications and variations are intended to be included herein within the scope of this present subject matter.

Embodiments of the subject matter and the functional operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer program products, i.e., one or more modules of computer program instructions encoded on a tangible program carrier for execution by, or to control the operation of, data processing apparatus. The tangible program carrier may be a computer readable medium as discussed above. The computer readable medium may be a machine-readable storage device, a machine-readable storage substrate, a memory device, or a combination of one or more of them.

The term “processor” encompasses all apparatus, devices, and machines for processing data, including by way of example a programmable processor, a computer, or multiple processors or computers. The processor may include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) may be written in any form of programming language, including compiled or interpreted languages, or declarative or procedural languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), to name just a few.

Computer readable media suitable for storing computer program instructions and data include all forms data memory including nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments of the subject matter described herein may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, input from the user may be received in any form, including acoustic, speech, or tactile input.

Embodiments of the subject matter described herein may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the subject matter described herein, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this description may contain many specifics, these should not be construed as limitations on the scope thereof, but rather as descriptions of features that may be specific to particular embodiments. Certain features that have been heretofore described in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and may even be initially claimed as such, one or more features from a claimed combination may in some cases be excised from the combination, and the claimed combination may be directed to a subcombination or variation of a subcombination.

Similarly, while operations are depicted in the drawings or figures in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

As shown by the various configurations and embodiments illustrated in FIGS. 1-16, various embodiments for a method and system for providing access to health care information have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

We claim:

1. A computer system comprising:
a computer readable storage medium being encoded with computer program code; and
a processor coupled with the computer readable storage medium, the processor being configured to execute the computer program code for providing access to health care information of one or more individuals, the computer program code being arranged to cause the processor to:
provide security measures for access to the health care information,
provide an interactive patient interface for the one or more individuals to the health care information,
provide an interactive provider interface for one or more health care providers relating to the health care information of a respective individual, and
allow access to the health care information from any of the health care providers and respective individual as a function of a security level granted thereto.

2. The system of claim 1 wherein the granted security level is dependent upon one or both whether the individual or provider is the originating source of the respective health care information and the type of entity the provider or individual is or is associated with.

3. The system of claim 1 wherein access is limited to one selected from the group of viewing health care information, modifying health care information, inputting health care information, receiving health care information, and combinations thereof.

4. The system of claim 1 wherein the health care information is selected from the group consisting of active medications, inactive medications, medication lists, drug interactions, physician's instructions, physician's notes, disease interactions, dosage, dose warnings, x-ray images, x-ray information, prescription information, hospital records, lab results, procedure information, procedure results, insurance information, pharmaceutical information, and combinations thereof.

5. The system of claim 1 wherein the health care provider is selected from the group consisting of a prescription switching company, pharmacy benefit manager, an e-script company, an insurance company, a pharmacy, a hospital, a physician, a physician's office, a radiologist, a pathologist, a laboratory and blood chemistry company, a radiology company, a pharmaceutical company, and combinations thereof.

6. The system of claim 1 wherein the interactive patient interface includes one or more of an active medications list, an all prescription list, and an inactive medications list.

7. The system of claim 6 wherein each of the lists includes one or more of frequency of prescription, quantity, duration of prescription, prescription notes, prescribing physician, Rx number, date of prescription, pharmaceutical or trademark name of prescription, and number of refills remaining related to a medication on that list.

8. The system of claim 1 wherein the interactive patient and provider interfaces are graphical user interfaces.

9. The system of claim 1 wherein the interactive patient interface includes hyperlinked pages to medical records, medication records, lab results, x-rays and procedure records, physician's notes, hospital records, and combinations thereof.

10. The system of claim 1 wherein the interactive patient interface includes one or more sections for medical or non-medical advertisements.

11. The system of claim 1 wherein the interactive provider interface includes one or both of an active medications list and an all prescription list.

12. The system of claim 11 wherein each of the lists includes one or more of frequency of prescription, quantity, duration of prescription, prescription notes, prescribing physician, Rx number, date of prescription, pharmaceutical or trademark name of prescription, and number of refills remaining related to a medication on that list.

13. The system of claim 1 wherein the interactive provider interface includes hyperlinked pages to medical records, medication records, lab results, x-rays and procedure records, physician's notes, hospital records, and combinations thereof.

14. The system of claim 1 wherein the interactive provider interface includes one or more sections for medical or non-medical advertisements.

15. The system of claim 1 wherein the security measures are selected from the group consisting of data encryption, time-limited passwords, biometrics, alphanumeric criteria for passwords, passmarks, security questions, know your customer criteria, personal identification numbers, and combinations thereof.

16. The system of claim 1 wherein the health care information is stored on a server remote from the computer system.

17. A method of providing a centralized source of health care information for an individual comprising the steps of:
providing security measures for access to health care information of an individual;
providing an interactive patient interface from a processor for the individual to the health care information;
providing an interactive provider interface for one or more health care providers of the individual; and
allowing access to the health care information from any of the health care providers and individual as a function of a security level granted thereto.

18. The method of claim 17 wherein the granted security level is dependent upon one or both whether the individual or provider is the originating source of the respective health care information and the type of entity the provider is or is associated with.

19. The method of claim 17 wherein the step of allowing access further comprises viewing health care information, modifying health care information, inputting health care information, receiving health care information, and combinations thereof as a function of a security level granted to the health care provider or individual.

20. The method of claim 17 wherein the step of providing an interactive patient interface further comprises providing a web page to the individual having one or more of an active medications list, an all prescription list, and an inactive medications list.

21. The method of claim 20 wherein the step of allowing access further comprises allowing the individual to change frequency of prescription, duration of prescription, prescription notes, and pharmaceutical or trademark name of prescription related to a medication on a respective list.

22. The method of claim 17 wherein the step of providing an interactive patient interface further comprises providing hyperlinked pages to medical records, medication records, lab results, x-rays and procedure records, physician's notes, hospital records, and combinations thereof.

23. The method of claim 22 wherein the step of allowing access further comprises allowing the individual to change information in the medical records, medication records, lab results, x-rays and procedure records, physician's notes, or hospital records.

24. The method of claim 17 wherein the step of providing an interactive provider interface further comprises providing a web page to the provider having one or more of an active medications list and an all prescription list.

25. The method of claim 24 wherein the step of allowing access further comprises allowing the provider to change frequency of prescription, duration of prescription, prescription notes, and pharmaceutical or trademark name of prescription related to a medication on a respective list.

26. The method of claim 17 wherein the step of providing an interactive provider interface further comprises providing hyperlinked pages to medical records, medication records, lab results, x-rays and procedure records, physician's notes, hospital records, and combinations thereof.

27. The method of claim 26 wherein the step of allowing access further comprises allowing the provider to change information in the medical records, medication records, lab results, x-rays and procedure records, physician's notes, or hospital records.

28. The method of claim 17 wherein the security measures are selected from the group consisting of data encryption, time-limited passwords, biometrics, alphanumeric criteria for passwords, passmarks, security questions, know your customer criteria, personal identification numbers, and combinations thereof.

29. The method of claim 17 wherein the health care information is selected from the group consisting of active medications, inactive medications, medication lists, drug interactions, physician's instructions, physician's notes, disease interactions, dosage, dose warnings, x-ray images, x-ray information, prescription information, hospital records, lab results, procedure information, procedure results, insurance information, pharmaceutical information, and combinations thereof.

30. The method of claim 17 wherein the health care provider is selected from the group consisting of a prescription switching company, pharmacy benefit manager, an e-script company, an insurance company, a pharmacy, a hospital, a physician, a physician's office, a radiologist, a pathologist, a laboratory and blood chemistry company, a radiology company, a pharmaceutical company, and combinations thereof.

31. A method of providing an updated medical record for an individual comprising the steps of:
providing security measures for access to health care information of an individual;
providing an interactive patient interface from a processor for the individual to the health care information, the interactive patient interface including an active medications list, an all prescription list, and an inactive medications list;
providing an interactive provider interface for one or more health care providers of the individual, the interactive provider interface including an active medications list and an all prescription list; and
allowing access to the health care information from any of the health care providers and individual as a function of a security level granted thereto,
wherein the step of allowing access includes changing one or more of the frequency of prescription, duration of prescription, prescription notes, and pharmaceutical or trademark name of prescription related to a medication on a respective list.

32. The method of claim 31 wherein the step of providing an interactive patient interface further comprises providing hyperlinked pages to medical records, medication records, lab results, x-rays and procedure records, physician's notes, hospital records, and combinations thereof.

33. The method of claim 32 wherein the step of allowing access further comprises allowing the individual to change information in the medical records, medication records, lab results, x-rays and procedure records, physician's notes, or hospital records.

34. The method of claim 31 wherein the step of providing an interactive provider interface further comprises providing hyperlinked pages to medical records, medication records, lab results, x-rays and procedure records, physician's notes, hospital records, and combinations thereof.

35. The method of claim 34 wherein the step of allowing access further comprises allowing the provider to change information in the medical records, medication records, lab results, x-rays and procedure records, physician's notes, or hospital records.
